(19) United States
(12) Patent Application Publication
(10) Pub. No.: US 2022/0004923 A1
(43) Pub. Date: Jan. 6, 2022

(54) SYSTEMS AND METHODS FOR MODEL EXPLANATION

(71) Applicant: ZestFinance, Inc., Burbank, CA (US)

(72) Inventors: Sean Kamkar, Los Angeles, CA (US); Geoffrey Ward, Canada Flintridge, CA (US)

(73) Assignee: ZestFinance, Inc., Burbank, CA (US)

(21) Appl. No.: 17/364,991

(22) Filed: Jul. 1, 2021

Related U.S. Application Data
(60) Provisional application No. 63/046,977, filed on Jul. 1, 2020.

(51) Int. Cl. G06N 20/00; G06K 9/62; G06Q 40/02

(52) U.S. Cl. CPC G06N 20/00; G06Q 40/025; G06K 9/6212; G06K 9/623

(57) ABSTRACT

Systems and methods for model explanation are disclosed. In one embodiment, the disclosed process determines a score based on a scoring function and a plurality of values associated with a plurality of features of a denied credit applicant. (e.g., credit score of 550, no loans repaid, etc.). The process then determines a score of an approved credit applicant. (e.g., credit score of 750, 3 loans repaid, etc.). A next differential credit assignment associated with the current denied/approved pair is then calculated. If a convergence stopping criteria, (e.g., current accuracy>99% based on a statistical t-distribution) is not satisfied, the process repeats for a different approved credit applicant. When the convergence stopping criteria is satisfied, explanation information is generated. For example, the explanation information may include an adverse action reason code, fairness metric, disparate impact metric, human readable text, feature importance metric, credit value, and/or an importance rank.

### TECHNICAL FIELD

This invention relates generally to the machine learning field, and more specifically to a new and useful model explanation system and method in the machine learning field.

### BACKGROUND

Models used by machine learning systems (e.g., ensemble models) are often hard to explain and trust using common methods for model explanation. There is a need in the machine learning field to provide insight into operation of machine learning systems.

### BRIEF DESCRIPTION OF THE FIGURES

FIGS. 1A-C are schematic representations of systems, in accordance with embodiments.

FIG. 2A-B are schematic representations of methods, in accordance with embodiments.

FIG. 3 is a flowchart of an example process of generating explanation information associated with denied credit applicant in a machine learning system.

FIG. 4 is a flowchart of an example process of generating explanation information associated with minority credit applicant in a machine learning system.

FIG. 5 is a flowchart of an example process of generating explanation information associated with recent credit applicant in a machine learning system.

FIG. 6 is a flowchart of an example process of generating explanation information associated with feature importance in a machine learning system.

### DESCRIPTION OF THE PREFERRED EMBODIMENTS

The following description of the preferred embodiments is not intended to limit the disclosure to these preferred embodiments, but rather to enable any person skilled in the art to make and use such embodiments.

There is a need in the machine learning field to provide insight into operation of machine learning systems. Such insight can be provided by evaluating operation of a machine learning system based on evaluation criteria (e.g., constraints on results generated by the machine learning system, constraints on comparisons among results generated by the machine learning system from one or more inputs, etc.). Evaluation results for a machine learning system can be used to assess the safety and soundness of the model, and its ability to comply with relevant laws and regulations. Evaluation results can also be used to monitor the machine learning system, during development of a model used by the machine learning system and/or during production (e.g., to provide an explanation or reasons for a result generated based on an input).

A model may be used in a variety of business contexts, including, without limitation: credit underwriting, marketing automation, automated trading, automated radiology and medical diagnosis, call center quality monitoring, interactive voice response, video labeling, transaction monitoring for fraud, inventory projection, reserve projection and other applications.

In embodiments, the model may be any suitable function that receives inputs (features, predictors, input variables, numeric or categorical) and produces an output (prediction). Any suitable method may be used to train the model such as: linear regression and classification, logistic regression, CART, random forest, gradient boosting/xgboost, neural networks, including: a perceptron, a feed-forward neural network, an autoencoder, a probabilistic network, a convolutional neural network, a radial basis function network, a multilayer perceptron, a deep neural network, or a recurrent neural network, including: Boltzman machines, echo state networks, long short-term memory (LSTM), hierarchical neural networks, stochastic neural networks.

In some embodiments, the model is trained using an adversarial training process such as the process described in U.S. Pat. No. 10,977,729.

In certain embodiments, the model is a linear ensemble of a plurality of models, each model based on one or more modeling techniques, either being a tree model or differentiable model. In some embodiments a tree model in the ensemble is a gradient boosted tree. In other embodiments a tree model in the ensemble is a random forest, a decision tree, a regression tree, or other tree model or equivalent stochastic rule-set. In some embodiments a differentiable model in the ensemble is a linear model. In other embodiments a differentiable model in the ensemble is a polynomial, a perceptron, a neural network, a deep neural network, a convolutional neural network, or recurrent neural network such as LSTM. In some embodiments a neural network in the ensemble uses the relu activation function, in other embodiments a neural network in the ensemble uses the sigmoid activation function, and further embodiments use other computable activation functions. In other embodiments, the model is not an ensemble of many sub-models, but rather a single model, either of tree or differentiable model, as described above and without limitation, and must be compared to one or more other tree or differentiable models. In other embodiments, an ensemble model or single model must be compared to a variety of other models, of both single and ensemble types. In other embodiments, there are no constraints placed upon the shared input features sets that are used by the models under consideration. For example, model A uses feature set a and model B uses feature set b; the sets may be identical (a=b), the sets may be disjoint (a∪b=0), the sets may be subsets of one another (a⊂b or b⊂a), or the sets may share similar features (ab0, abab). In other embodiments, the model is a composition of models, such as an ensemble model comprised of xgboost and neural network submodels and combined using a neural network meta-model.

Evaluating a machine learning system can include identifying the importance of input features on results generated by the system (e.g., feature importance), determining how results generated for a first population of inputs compare to results generate for a second population of inputs (e.g., by comparing populations corresponding to underrepresented groups with majority groups as is common in disparate impact analysis, or by comparing the drivers of difference in scores by region, segment, or other selection criteria), identifying key factors (input features or aggregations of input features) that contribute to a result generated for a specific input (e.g., key factor analysis, adverse action reason code generation), and evaluating the system based on fairness criteria (such as, for instance, approval rate ratios, difference in approval rate, difference in profit, profit ratios, false positive rate, false negative rate, etc.). Evaluation outputs can include tables with numerical statistics or charts that indicate how a score changes as an input changes.

Evaluation can include generating explanation information by performing a credit assignment process that assigns credit to the data variables of inputs used by a model of the machine learning system to generate a score or result, and using the explanation information to generate an evaluation result. The data variables of inputs used by a model may include various predictors, including: numeric variables, binary variables, categorical variables, ratios, rates, values, times, amounts, quantities, matrices, scores, or outputs of other models. The result may be a score, a probability, a binary flag, or other numeric value. The evaluation result may include model documentation, analysis, and the like as described above, and any other analysis that includes or is based on the importance of inputs.

The credit assignment process can include a differential credit assignment process that performs credit assignment for an evaluation input by using one or more reference inputs. In some embodiments, the credit assignment method is based on Shapley values. In other embodiments, the credit assignment method is based on Aumann-Shapley values. In some embodiments, the credit assignment method is based on Tree SHAP, Kernel SHAP, interventional tree SHAP, Integrated Gradients, Generalized Integrated Gradients, or a combination thereof.

Tree SHAP is disclosed in “Consistent Individualized Feature Attribution for Tree Ensembles”, by Scott Lundberg, et al., Mar. 7, 2019, University of Washington, available at https://arxiv.org/pdf/1802.03888.pdf, the contents of which is incorporated by reference herein.

Kernel SHAP is disclosed in “A Unified Approach to Interpreting Model Predictions”, by Scott Lundberg et al, Nov. 25, 2017, 31^{st} Conference on Neural Information Processing Systems, available at https://arxiv.org/pdf/1705.07874.pdf, the contents of which is incorporated by reference herein.

Interval Tree SHAP is disclosed in Lundberg, S. M., Erion, G., Chen, H. et al. From local explanations to global understanding with explainable AI for trees. Nat Mach Intell 2, 56-67 (2020). https://doi.org/10.1038/s42256-019-0138-9, the contents of which is incorporated by reference herein.

Integrated Gradients is disclosed in “Axiomatic Attribution for Deep Networks”, by Mukund Sundararajan et al., Jun. 13, 2017, Proceedings of the 34^{th} International Conference on Machine Learning available at https://arxiv.org/pdf/1703.01365.pdf, the contents of which is incorporated by reference herein.

Generalized Integrated Gradients is disclosed in “Generalized Integrated Gradients: A practical method for explaining diverse ensembles”, by John Merrill et al., Sep. 6, 2019, ZestFinance, Inc., available at https://arxiv.org/pdf/1909.01869.pdf, the contents of which is incorporated by reference herein.

Evaluation inputs can be generated inputs, inputs from a population of training data, inputs from a population of validation data, inputs from a population of production data (e.g., actual inputs processed by the machine learning system in a production environment), inputs from a synthetically generated sample of data from a given distribution, etc. In some embodiments, a synthetically generated sample of data from a given distribution is generated based on a generative model. In some embodiments the generative model is a linear model, an empirical measure, a Gaussian Mixture Model, a Hidden Markov Model, a Bayesian model, a Boltzman Machine, a Variational autoencoder, or a Generative Adversarial Network. Reference inputs can be generated inputs, inputs from a population of training data, inputs from a population of validation data, inputs from a population of production data (e.g., actual inputs processed by the machine learning system in a production environment), inputs from a synthetically generated sample of data from a given distribution, etc. The total population of evaluation inputs and/or reference inputs can increase as new inputs are processed by the machine learning system (e.g., in a production environment). For example, in a credit risk modeling implementation, each newly evaluated credit application is added to the population of inputs that can be used as evaluation inputs, and optionally reference inputs. Thus, as more inputs are processed by the machine learning system, the number of computations performed during evaluation of the machine learning system can increase.

Generation of explanation information for a machine learning system by performing a differential credit assignment process with large datasets (from which evaluation inputs and reference inputs are selected) can be slow and/or computationally expensive. For example, generating explanation information for feature importance (e.g., by comparing all points by all other points), disparate impact (e.g., by comparing minority applicants with non-minority applicants), or key factors (e.g., by comparing a denied credit applicant with a set of approved applicants), can be an O(n*m) algorithm, where n: number of test points (evaluation inputs), m: number of reference points (reference inputs). A dataset with a million data points may require a trillion comparisons.

Improved systems and methods for explaining and evaluating machine learning systems are disclosed herein.

The system functions to evaluate at least one machine learning system or model. The system includes at least an explanation system that generates explanation information used to generate evaluation results. In some variations, at least one component of the system performs at least a portion of the method.

The method can function to evaluate a machine learning system. The method can include generation of explanation information for the machine learning system. The explanation information can be generated by performing a credit assignment process. Performing the credit assignment process (e.g., a differential credit assignment process, etc.) can include performing computations from one or more inputs (e.g., evaluation inputs, reference inputs, etc.) (e.g., by using the machine learning system). In some variations, the inputs are sampled (e.g., by performing a Monte Carlo sampling process) from at least one dataset that includes a plurality of rows that can be used as inputs (e.g., evaluation inputs, reference inputs, etc.). Sampling can include performing one or more sampling iterations until at least one stopping criteria is satisfied.

Stopping criteria can include any suitable type of stopping criteria (e.g., a number of iterations, a wall-clock runtime limit, an accuracy constraint, an uncertainty constraint, a performance constraint, convergence stopping criteria, etc.). In some variations, the stopping criteria includes an accuracy constraint that specifies a minimum value for a sampling metric that identifies convergence of sample-based explanation information (generated from the sample being evaluated) to ideal explanation information (generated without performing sampling). In other words, stopping criteria can be used to control the system to stop sampling when a sampling metric computed for the current sample indicates that the results generated by using the current sample are likely to have an accuracy above an accuracy threshold related to the accuracy constraint. In this way, the present invention performs the practical and useful function of limiting the number of calculations to those required to determine an answer with sufficient accuracy, certainty, wall-clock run time, or combination thereof. In some embodiments, the stopping criteria are specified by an end-user via a user interface. In some embodiments, the stopping criteria are specified based on a grid search or analysis of outcomes. In other embodiments, the stopping criteria are determined based on a machine learning model.

Convergence stopping criteria can include a value, a confidence interval, an estimate, tolerance, range, rule, etc., that can be compared with a sampling metric computed for a sample (or sampling iteration) of the one or more datasets being sampled to determine whether to stop sampling and invoke the explanation system and generate evaluation results. The sampling metric can be computed by using the inputs sampled in the sampling iteration (and optionally inputs sampled in any preceding iterations). The sampling metric can be any suitable type of metric that can measure asymptotic convergence of sample-based explanation information (generated from the sample being evaluated) to ideal explanation information (generated without performing sampling). In some variations, the sampling metric is a t-statistic (e.g., bound on a statistical t-distribution). However, any suitable sampling metric can be used.

Variations of this technology can afford several benefits and/or advantages.

First, by performing sampling, computational performance can be improved by orders of magnitude (e.g., runtimes of days to minutes) as compared with generation of explanation information using a full data set.

Second, by performing sampling, statistical confidence measures can be generated for any explanatory output. These measures provide insight as to the sensitivity of the dataset, the model, or the particular application, e.g., Feature Importance, Disparate Impact, or Key Factors, which are not available with the generation of information using a full dataset. This estimation of statistical confidence is useful when determining whether to rely upon a given explanatory output. In some embodiments, a lower confidence measure associated with an explanatory output might cause a system based on a machine learning model to route the model-based decision to humans for further review. In other embodiments, a lower mean or median confidence measure associated with explanatory outputs for a population segment is used to determine whether to employ a given model on the segment. In another embodiment, the variance in confidence measures associated with explanatory outputs for a population is used to evaluate the model's safety and soundness.

Third, by performing one or more sampling iterations until a sampling metric that measures convergence to ideal explanation information (generated without performing sampling) is satisfied, samples that satisfy accuracy constraints can be generated. In this manner, performance can be improved without impacting accuracy beyond a specified threshold. Moreover in some embodiments, the method herein employs sampling with replacement such that multiple invocations of the model on the same input data set are computed and the variance in outputs is reflected in the accuracy measure. This is useful when the underlying explanation algorithm is itself based on approximate methods such as e.g., numerical integration methods, which estimate the integral using quadratures, such as those methods employed by Integrated Gradients, Generalized Integrated Gradients, interventional SHAP, tree SHAP, kernel SHAP and any other explainability method relying on approximate or numerical methods.

Further benefits are provided by the system and method disclosed herein.

Various systems are disclosed herein. In some variations, the system can be any suitable type of system that uses one or more of artificial intelligence (AI), machine learning, predictive models, and the like. Example systems include credit granting systems, transaction processing systems, drug evaluation systems, college admissions systems, human resources systems, applicant screening systems, surveillance systems, law enforcement systems, military systems, military targeting systems, advertising systems, customer support systems, call center systems, payment systems, procurement systems, and the like. In some variations, the system functions to train one or more models. In some variations, the system functions to use one or more models to generate an output that can be used to make a decision, populate a report, trigger an action, or create a concrete and tangible result, such as approving a mortgage or credit card, classifying a transaction as fraud, determining whether an applicant is admitted to a school or other program, deciding a course of treatment for a patient, pricing an asset for sale, selecting an email to send to a customer, evaluating vendor risk, and the like.

In some variations, the model is a marketing model, wherein the model rank orders the likelihood a consumer will respond to a solicitation for a loan, be approved, and choose to fund the loan or use the credit card issued. In other variations, the model is an identity fraud model, wherein the model considers credit attributes and other factors to determine whether the applicant is real or a synthetic identity constructed to mislead a scoring model or manual underwriter. In other variations, the model is an underwriting model, wherein the model calculates the likelihood a consumer will repay their loan based on credit attributes and other information. In some variations, the model is a pricing model, wherein the model calculates the likelihood a consumer will book and repay their loan based on credit attributes and an APR. In other variations, the model is a line assignment model, wherein the model calculates the likelihood a consumer will book and repay their loan based on credit attributes and a credit line amount. In other variations, the model is a portfolio review model, wherein the model calculates the likelihood a consumer will become delinquent in their repayment schedule after the loan was booked.

In some variations, the input variables in the model include credit attributes such as: number of bankruptcies, number of delinquencies e.g. in the last 3 months, number of delinquencies e.g. in the last 6 months, total count of past delinquencies, a count of past delinquencies on a secured product, a count of past delinquencies on a revolving product, and the like. In other variations, the input variables include utilization statistics such as the average balance on all revolving accounts over the last e.g. 3, 6, 12 or 24 months, or the average percentage of available revolving credit utilized in the last e.g. 3, 6, 12 or 24 months. In some variations the input variables in the model include the total number of inquiries for a credit product, the number of inquiries for an unsecured product, the number of inquiries for an unsecured product in the last e.g. 3, 6, 12 or 24 months, and the like. In some variations, the credit attributes are based on a credit report from a credit bureau. In some variations the credit attributes are based on credit data from a distributed ledger system. In some variations the distributed ledger system is a blockchain. In other variations the model input attributes include demand deposit account attributes such as the average monthly checking and saving account balances, a count of negative balance events, and a count of non-sufficient funds notices sent. In some variations the demand deposit account data is retrieved from a core banking system such as DNA® from Fiserv, Signature® from Fiserv, Symitar®, Episys, Oracle FLEXCUBE. Fidelity Information Services Systematics Core Banking, Temenos Transact, and the like. In other variations the demand deposit account data is retrieved via OpenBanking APIs. In other variations demand deposit account data and other financial data which may include assets information, account balances, and monthly obligations are gathered (e.g., via services such as Plaid or Yodlee) and associated with other credit data related to each consumer.

The system can be a local (e.g., on-premises) system, a cloud-based system, or any combination of local and cloud-based systems. The system can be a single-tenant system, a multi-tenant system, or a combination of single-tenant and multi-tenant components. The system can be a mobile device, wearable, or personal computer running a consumer application.

In some variations, the system (e.g., 100) functions to evaluate at least one machine learning system (e.g., 112) or model (e.g., 111). The system includes at least an explanation system (e.g., 110) that generates explanation information used to generate evaluation results. In some variations, at least one component of the system performs at least a portion of the method disclosed herein.

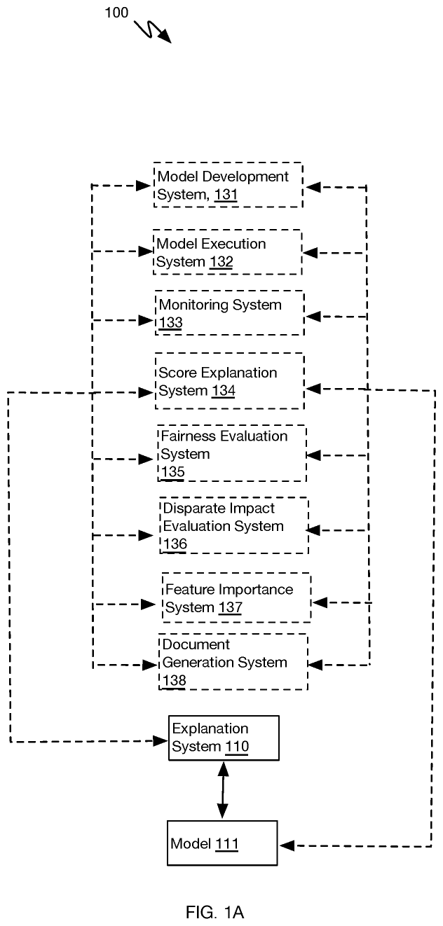

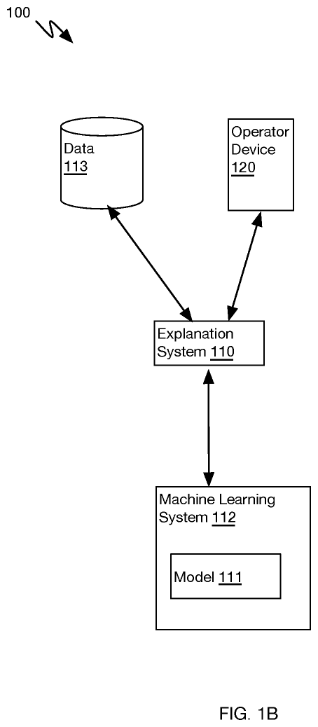

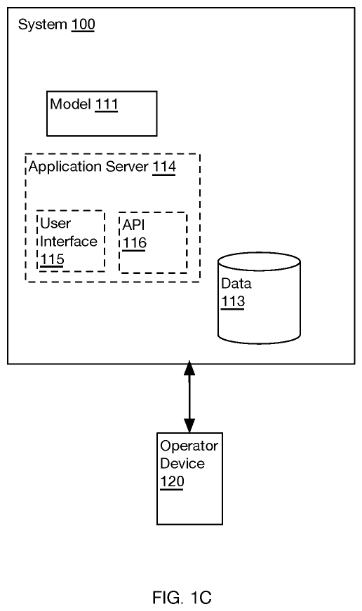

In some variations, the system (e.g., 100) includes one or more of: a machine learning system (e.g., 112 shown in FIG. 1B) (that includes one or more models); a machine learning model (e.g., 111); a model development system (e.g., 131); a model execution system (e.g., 132); a monitoring system (e.g., 133); a score (result) explanation system (e.g., 134); a fairness evaluation system (e.g., 135); a disparate impact evaluation system (e.g., 136); a feature importance system (e.g., 137); a document generation system (e.g., 138); an application programming interface (API) (e.g., 116 shown in FIG. 1C); a user interface (e.g., 115 shown in FIG. 1C), a data storage device (e.g., 113 shown in FIGS. 1B-C); and an application server (e.g., 114 shown in FIG. 1C). However, the system can include any suitable systems, modules, or components. The explanation system (e.g., no) can be a stand-alone component of the system, or can be included in another component of the system.

In some variations, the model development system 131 provides a graphical user interface which allows an operator (e.g., via an operator device 120, shown in FIG. 1B) to access a programming environment and tools such as R or python, and contains libraries and tools which allow the operator to prepare, build, train, verify, and publish machine learning models. In some variations, the model development system 131 provides a graphical user interface which allows an operator (e.g., via 120) to access a model development workflow that guides a business user through the process of creating and analyzing a predictive model.

In some variations, the model execution system 132 provides tools and services that allow machine learning models to be published, verified, and executed.

In some variations, the document generation system 138, includes tools that utilize a semantic layer that stores and provides data about variables, features, models and the modeling process. In some variations, the semantic layer is a knowledge graph stored in a repository. In some variations, the repository is a storage system. In some variations, the repository is included in a storage medium. In some variations, the storage system is a database or filesystem and the storage medium is a hard drive.

In some variations, the components of the system can be arranged in any suitable fashion.

FIGS. 1A-C show exemplary systems 100 in accordance with variations.

In some variations, one or more of the components of the system are implemented as a hardware device that includes one or more of a processor (e.g., a CPU (central processing unit), GPU (graphics processing unit), NPU (neural processing unit), etc.), a display device, a memory, a storage device, an audible output device, an input device, an output device, and a communication interface. In some variations, one or more components included in hardware device are communicatively coupled via a bus. In some variations, one or more components included in the hardware system are communicatively coupled to an external system (e.g., an operator device 120) via the communication interface.

The communication interface functions to communicate data between the hardware system and another device (e.g., the operator device 120) via a network (e.g., a private network, a public network, the Internet, and the like).

In some variations, the storage device includes the machine-executable instructions for performing at least a portion of the method 200 described herein.

In some variations, the storage device includes data 113. In some variations, the data 113 includes one or more of training data, outputs of the model in, accuracy metrics, fairness metrics, economic projections, explanation information, and the like.

The input device functions to receive user input. In some variations, the input device includes at least one of buttons and a touch screen input device (e.g., a capacitive touch input device).

The method can function to evaluate a machine learning system (e.g., 112 shown in FIG. 1B). The method can include one or more of: accessing parameters S210; accessing at least one data set for the machine learning system S220; generating explanation information for the machine learning system (e.g., by using at least one accessed data set for the machine learning system) S230; generating at least one evaluation result by using at least a portion of the generated explanation information S240; and providing at least one evaluation result (e.g., to an internal or external system or module) S250.

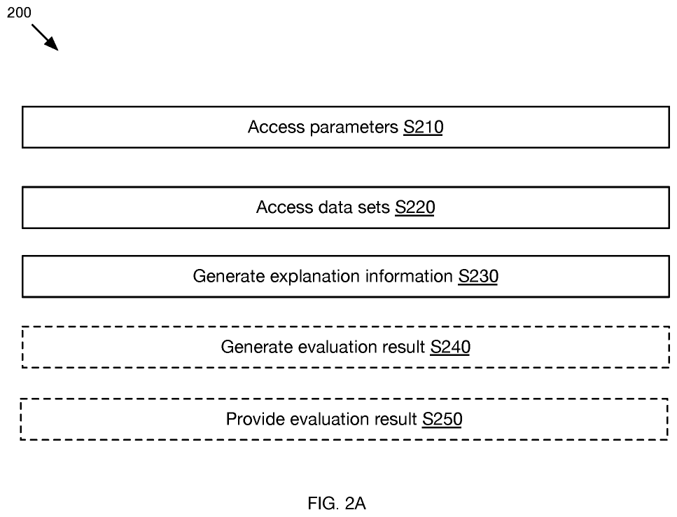

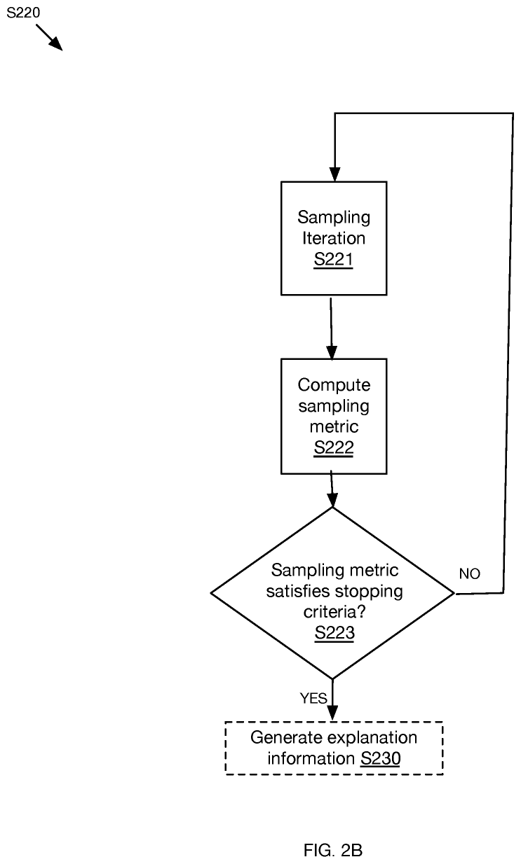

FIGS. 2A-B are representations of a method 200, according to variations.

In some variations, the parameters accessed at S210 function to control processes performed at one or more of S220-S240.

The parameters can be accessed at S210 in any suitable manner. Parameters can be accessed from one or more of: a storage device (e.g., 113), a network interface device, and an input device (e.g., a user input device, sensor, etc.). Parameters can be received via an Application Programming Interface (API) (e.g., 116), a user interface (e.g., 115), etc. In some variations, parameters are provided by an operator device (e.g., 120). However, parameters can otherwise be accessed.

Parameters can include one or more of: filtering criteria, identifiers for selected features, selected feature values, performance constraints, accuracy constraints, and sampling parameters. Sampling parameters can include one or more of: a sampling method (e.g., sampling with replacement), a sampling seed (random seed), a sampling batch size, sampling stopping criteria, etc. In some variations, sampling parameters are derived from one or more of performance constraints and accuracy constraints. In some embodiments, sampling parameters are determined based on the outputs of a model.

In some implementations, an initial set of sampling parameters are derived based on one or more of performance constraints and accuracy constraints. Data sets are accessed by using the initial set of sampling parameters, and the accessed data is used to generate explanation information (or evaluation results). Actual performance for generation of explanation information (or evaluation results) is determined, and the actual performance is compared with the performance constraints. If the actual performance does not satisfy the performance constraints, the initial set of sampling parameters is updated.

However, any suitable parameters can be accessed at S210 from any suitable source.

In an example, if maximum accuracy is important (as identified by a performance constraint), evaluation results should be generated (e.g., at S240) by using full data sets. However, if performance constraints are specified, the evaluation results can be generated by using one or more samples of a full data set by using sampling parameters that can satisfy the performance constraints and any accuracy constraints. In another example, if a certainty of p<0.05 is required, the data may be sampled iteratively until the desired level of certainty is achieved.

In some variations, the evaluation results can be generated by using explicitly specified sampling parameters (which may identify that no sampling should be performed, a specific number of samples should be used, etc.).

Accessing at least one data set for the machine learning system S220 can include accessing one or more inputs. In some variations, the inputs are accessed from at least one dataset that includes a plurality of rows that can be used as inputs (e.g., evaluation inputs, reference inputs, etc.). Accessing one or more inputs can include accessing a set of reference inputs, and optionally accessing a set of evaluation inputs.

In some variations, accessing inputs includes filtering a data set based on filtering criteria, and then accessing the inputs from the filtered data asset. A filter can be applied to select data sets having non-null values for selected features, data sets having specific values for selected features, data sets having specific value ranges for selected features, datasets having specific segment identifiers, data sets having specific model scores. However, other selection criteria can be used to access inputs. However, data sets can be otherwise filtered. In an example, in a case of generating explanation information for generating explained variance information for a feature, the data sets can be filtered for data sets having non-null values for the feature for which explained variance information is to be generated.

In some variations, the inputs are sampled from at least one dataset. Sampling can be performed using any suitable sampling method. In some variations, sampling is performed in accordance with parameters accessed at S210. In some variations, random sampling is performed. In some variations, sampling is performed by performing a Monte Carlo sampling process (e.g., a Smart Monte Carlo process). In some variations, sampling is performed by performing sampling with replacement. In other variations, the sampling method is a stratified sampling method. However, other prescriptive sampling techniques can otherwise be performed.

In a first variation, evaluation inputs and reference inputs are sampled separately (e.g., using different sampling parameters, using same sampling parameters, using different sampling methods, using same sampling methods, etc.). In some implementations, evaluation inputs are randomly sampled by using a first seed and reference inputs are sampled by using a second seed different from the first seed. In some implementations the random seed (e.g., the first seed, the second seed, etc.) used in the sampling process is recorded in memory or on disk so as to facilitate reproducibility. In a second variation, evaluation inputs and reference inputs are sampled simultaneously to generate a combined sample, and evaluation inputs and reference inputs are selected from the combined sample. However, inputs can otherwise be sampled.

Sampling can include performing one or more sampling iterations (e.g., S221 shown in FIG. 2B) until at least one stopping criteria is satisfied.

Stopping criteria can include any suitable type of stopping criteria (e.g., a number of iterations, a time, convergence stopping criteria, etc.). Stopping criteria can include cost stopping criteria for stopping sampling when at least one cost threshold is reached or exceeded. In some embodiments the cost is a computational cost. In other embodiments the cost is an economic cost. Stopping criteria can include absolute tolerance and relative tolerances. Convergence stopping criteria can include a value, estimate, tolerance, range, rule, etc., that can be compared (e.g. at S223 shown in FIG. 2B) with a sampling metric computed for a sample (or sampling iteration) of the one or more datasets being sampled to determine whether to stop sampling. The sampling metric can be computed by using the inputs sampled in the sampling iteration (and optionally inputs sampled in any preceding iterations). The sampling metric can be any suitable type of metric that can measure asymptotic convergence of sample-based explanation information (generated from the sample being evaluated) to ideal explanation information (generated without performing sampling). In some variations, the sampling metric is a t-statistic (e.g., bound on a statistical t-distribution). However, any suitable sampling metric can be used.

In some variations, repeated sampling iterations are preformed (e.g., at S221 shown in FIG. 2B) (e.g., performed by using Monte Carlo or another technique), in which a sample of a data set is accessed at each sampling iteration. The samples accessed at each iteration are combined to generate a combined sample, and the combined sample is used to generate explanation information (e.g., at S230), which can be used to generate evaluation results (e.g., at S240) (e.g., evaluation results for one or more of Feature Importance, Disparate Impact, Key Factors, etc.). As additional sampling iterations are performed to update the combined sample, the distribution of inputs included in the combined sample can be compared to a distribution for the complete data set that is being sampled. Similarly, as additional sampling iterations are performed to update the combined sample, the distribution of explanation information values (or evaluation results values) generated by using the combined sample can be compared to a distribution for explanation information values (or evaluation results values) generated by using the complete data set that is being sampled.

In some variations, the distributions (for inputs in a sample, for inputs in the complete data set, for explanation information values, for evaluation results values, etc.) can be computed in any suitable manner. In some variations, at least one distribution can be a normal distribution (or converge to a normal distribution as the number of sampling iterations increases). Alternatively, at least one distribution can be a t-distribution (or converge to a t-distribution as the number of sampling iterations increases).

Distributions can be compared in any suitable manner. In some variations, a statistical value (e.g., a mean, median, mode, variance, etc.) is computed for each distribution to be compared, and the distributions are compared by comparing the computed statistical values. The result of the comparison can be a sampling metric computed for the comparison.

In some variations, the sampling metric is determined (e.g., at S222 shown in FIG. 2B) according to the following equation:

$$\frac{\overline{X} - μ}{S / \sqrt{n}} \qquad Equation 1$$

In some implementations, X̅ is the sample mean for the sampling iteration in which n inputs (e.g., X₁, X₂, . . . Xₙ) are sampled from the data set. S is the estimate of the standard deviation for the population of the data set, and r is the population mean for the data set. X̅ is defined as shown in Equation 2.

$$\overline{X} = \frac{1}{n} {\sum }_{i = 1}^{n} {X}_{i} \qquad Equation 2$$

S² is defined as shown in Equation 3.

$${S}^{2} = \frac{1}{n - 1} {\sum }_{i = 1}^{n} {( {X}_{i} - \overline{X} )}^{2} \qquad Equation 3$$

The sampling metric can be computed for inputs included in a current sampling iteration, or inputs included in a combined sample that includes the inputs included in the current sampling iteration along with the inputs included in all previous sampling iterations.

Therefore, in some variations, the sampling metric can be computed from the number of inputs n included in the current sampling iteration, the inputs included in the current sampling iteration, and the population mean for the data set.

Alternatively, in some variations, the sampling metric can be determined from: the number of inputs n included in the combined sample, the inputs included in the combined sample, and the population mean for the data set.

In some variations, if the sampling metric satisfies the convergence stopping criteria (e.g., “YES” shown in FIG. 2B), then sampling stops. In some variations, if the sampling metric does not satisfy the convergence stopping criteria (e.g., “NO” shown in FIG. 2B), then a new sampling iteration is performed (e.g., at S221), and the inputs sampled in the new sampling iteration are used to compute an updated sampling metric (e.g., S222). Sampling continues (and new sampling iterations are performed) until a sampling iteration results in inputs from which a sampling metric that satisfies the convergence stopping criteria is computed. In some implementations, inputs included in the current sampling iteration and each previous sampling iteration are used to compute the sampling metric at S222.

Generating explanation information S230 can include performing a credit assignment process (e.g., by using at least one accessed data set for the machine learning system) to assign credit to one or more features used by the model (e.g., in) to generate output. In some variations, the explanation information generated at S230 includes credit values (e.g., Cₓᵢ) that are assigned to features used by the model. For example, if the model uses features X₁, X₂, X₃, then the explanation information includes credit values that are assigned to each of X₁, X₂, X₃ (e.g., “X₁::Cₓ₁, X₂::Cₓ₂, X₃::Cₓ₃”). The credit assignment values can be used to identify the impact of each feature on output generated by the model.

The credit values can be numerical values. Any suitable type of credit assignment process can be performed to assign credit values to features used by the model. In some variations, generating credit values includes generating a feature decomposition for at least one evaluation input. In some implementations, a feature decomposition identifies a credit value for each feature for a particular evaluation input (or model output generated by the model by using the evaluation input). For example, if the evaluation input includes features X₁, X₂, X₃, the feature decomposition for the evaluation input has contribution values for each feature (e.g., “{Cₓ₁, Cₓ₂, Cₓ₃}”).

A feature decomposition can be generated for an evaluation input by using a model or information related to the model. Information related to the model can include data describing the model, data generated by the model, model monitoring information and the like. Examples of model information that can be used to generate a feature decomposition for an evaluation input include one or more of: output generated by the model for the evaluation input, information identifying a tree structure of the model, information identifying boundary points of the model, a gradient generated by the model for the evaluation input, etc.).

In some variations, the credit assignment process is a differential credit assignment process, and one or more reference inputs (or a statistical value generated from one or more reference inputs) are used to generate a credit value (or a feature decomposition) for an evaluation input. In some embodiments the differential credit assignment process explains a difference in model score based on a reference input and an evaluation input. For example, if an evaluation input includes features X1, X2, . . . Xn with values x1, x2, . . . xn and assigned a score Sx by a model, and a reference including the same features Xi with values r1, r2, . . . rn and assigned a score Sr by the same model, the difference in score Sx-Sr equals the sum of the credit assignments Ci, for each of the features Xi. In some embodiments multiple reference values r1,1, . . . , rn,m are compared with the evaluation input and the average Ĉi of each of the m pair-wise differential credit assignments between \vec{x} and each \vec{r}. The reference inputs can be accessed in any suitable manner. In some implementations, the reference inputs are accessed from a data set. In a first example, reference inputs can include each input included in the data set. In a second example, the data set is partitioned into an evaluation data set and a reference data set, and the reference inputs include each row included in the reference data set. In a third example, the reference inputs include each input included in a sample of the data set. The sample can be generated as described herein for S220 (e.g., by performing one or more sampling iterations until at least one stopping criteria is satisfied). In some implementations, a statistical value for a plurality of reference inputs can be generated by performing any suitable statistical or arithmetic operation (e.g., summing, averaging, etc.). For example, for each feature of the reference inputs, the credit values can be averaged across all reference inputs to generate an average credit value, and the averaged credit values can represent an average of the plurality of reference inputs. Alternatively, for each feature of the reference inputs, the credit values can be summed across all reference inputs to generate a total credit value, and the total credit values can represent a total of the plurality of reference inputs.

Generating a feature decomposition can be performed in any suitable manner. Processes for generating feature decompositions are described in U.S. Patent Application Publication 2019/0279111, filed 8 Mar. 2019, entitled “SYSTEMS AND METHODS FOR PROVIDING MACHINE LEARNING MODEL EVALUATION BY USING DECOMPOSITION”, by Douglas C. Merrill et al, U.S. Patent Application Publication 2019/0378210, filed 7 Jun. 2019, entitled “SYSTEMS AND METHODS FOR DECOMPOSITION OF NON-DIFFERENTIABLE AND DIFFERENTIABLE MODELS”, by Douglas C. Merrill et al, U.S. patent application Ser. No. 16/688,789, filed 19 Nov. 2019, entitled “SYSTEMS AND METHODS FOR DECOMPOSITION OF DIFFERENTIABLE AND NON-DIFFERENTIABLE MODELS”, by John Wickens Lamb Merrill et al, the contents of each of which are incorporated herein.

U.S. Patent Application Publication 2019/0279111 describes an integrated gradients process that can be used to generate a feature decomposition for differentiable models. In some variations, the integrated gradients process generates a feature decomposition for an evaluation input relative to a reference input, and thus uses at a reference input to generate a feature decomposition for an evaluation input. In some implementations, the integrated gradients process includes generating a decomposition for an evaluation input by computing an integral of a gradient along a path from the evaluation input to the reference input.

U.S. Patent Application Publication 2019/0279111 also describes a decomposition process that can be used to generate a feature decomposition for non-differentiable models. In a first variation, a decomposition process for a non-differentiable model generates an absolute decomposition for an evaluation input. In a second variation a decomposition process for a non-differentiable model generates a relative decomposition for an evaluation input by using a reference input. In this second variation, a decomposition is generated for the evaluation input, a decomposition is generated for the reference input, and the decomposition values for the reference input are subtracted from the decomposition values for the evaluation input to generate a decomposition for the evaluation input relative to the reference input.

U.S. Patent Application Publication 2019/0378210 describes a process for generating a feature decomposition for non-differentiable models by using SHAP values. In a first variation, a decomposition process for a non-differentiable model generates a SHAP value for an evaluation input. In a second variation a decomposition process for a non-differentiable model generates a relative decomposition for an evaluation input by using a reference input. In this second variation, a SHAP value is generated for the evaluation input, a SHAP value is generated for the reference input, and the SHAP values for the reference input are subtracted from the SHAP values for the evaluation input to generate a SHAP value for the evaluation input relative to the reference input.

U.S. patent application Ser. No. 16/688,789 describes a generalized integrated gradients process that can be used to generate a feature decomposition for both differentiable and non-differentiable models. In some variations, the generalized integrated gradients process generates a feature decomposition for an evaluation input relative to a reference input, and thus uses a reference input to generate a feature decomposition for an evaluation input.

In a first variation, credit values (e.g., Cₓᵢ) are generated for a single input (evaluation input). In some implementations, generating credit values for an evaluation input includes generating a feature decomposition for the evaluation input. The credit values can be used to identify relative impact of each feature on an output generated by the model for the evaluation input. In this first variation, each feature is assigned a single credit value. In this first variation, only a single evaluation input is used to generate the credit values. The single input can be accessed in any suitable manner. In implementations in which a differential credit assignment process is used to generate a credit value, one or more reference inputs are used to generate the credit values. In some instances where several reference inputs are used to generate the credit values, generation of credit values is a one-to-many problem in which a computation is performed for each reference input.

By observing the credit values assigned to each feature, one can understand the impact of each feature on output generated by the model for the evaluation input. Example use cases include understanding why the model generated a particular credit score for an applicant, understanding why a credit applicant was denied credit, understanding why an autonomous system generated a particular control instruction, etc. In some implementations, credit values generated for a single evaluation input can be used to generate score explanations (e.g., by using the score explanation system 134).

In a second variation, credit values (e.g., Cₓᵢⱼ) are generated for several evaluation inputs. In some implementations, the evaluation inputs can be randomly selected. In some variations, the evaluation inputs can include a set of inputs that have the same value for all features except for a single feature (or group of features). In this manner, the effect of differing values for a single feature (or group of features) can be evaluated to see if certain values for a feature (or group of features) are more impactful on model output than others. This type of evaluation can be useful in explaining model variance.

In some implementations, generating credit values for several evaluation inputs includes generating a feature decomposition for each evaluation input. The credit values can be used to identify how features affect overall performance of the model across the several evaluation inputs. In this second variation, each feature is assigned a credit value for each evaluation input (e.g., Cₓᵢⱼ for feature i of evaluation input j). The evaluation inputs can be accessed in any suitable manner. In some implementations, the evaluation inputs are accessed from a data set. In implementations related to evaluating the effect of differing values for a single feature (or group of features), the data set can include inputs having differing values only for the feature (or group of features) being evaluated). For example, to evaluate feature X₃ for a model that uses features X₁, X₂, X₃, the data set can have inputs that each have the same value for features X₁, X₂, but differing values for feature X₃.

In a first example for accessing evaluation inputs, evaluations inputs can include each input included in the data set. In a second example, the data set is partitioned into an evaluation data set and a reference data set, and the evaluation inputs include each row included in the evaluation data set. In a third example, the evaluation inputs included each input included in a sample of the data set. The sample can be generated as described herein for S220 (e.g., by performing one or more sampling iterations until at least one stopping criteria is satisfied).

In some implementations, at least one statistical value is generated for each feature based on the credit values assigned to the feature. For example, the credit values assigned to a feature can be averaged to generate an average credit value for the feature across all of the evaluation inputs. Alternatively, the credit values assigned to a feature can be summed to generate a total credit value for the feature across all of the evaluation inputs.

In instances in which several reference inputs are used to generate the credit values, generation of credit values is a many-to-many problem in which for each evaluation input, a computation is performed for each reference input. In such instances, performance can be improved by reducing the number or reference inputs (and evaluation inputs) selected to generate the credit values. By virtue of performing sampling (as described herein for S220), the number of reference inputs (and optionally evaluation inputs) can be reduced, while satisfying a given set of parameters (e.g., accessed at S210). However, credit values assigned to a feature can be otherwise determined.

By observing the credit values assigned to each feature (or statistical values), one can understand the impact of each feature on the model's performance. In some implementations, credit values generated for several inputs can be used to explain variance, evaluate fairness of the model (e.g., by using the fairness evaluation system 135), evaluate disparate impact of the model (e.g., by using the disparate impact evaluation system 136), identify importance of features used by the model (e.g., by using the feature importance system 137), or generate documentation for the model (e.g., by using the document generation system 138).

In some variations, the explanation information generated at S230 is used to generate evaluation results at S240. As described herein, the explanation information generated at S230 can include credit values (e.g., Cₓᵢ) that are assigned to features used by the model.

In some implementations, the explanation system no generates the explanation information at S230, and optionally provides the explanation information to one or more of the systems 131-138 shown in FIG. 1A.

Generating evaluation results S240 can include generating one or more of: a list of model features to be removed from the model, updated model weights, a model score explanation, a fairness metric, a list of important features, a list of features ranked in order of importance, a disparate impact metric, a list of features that have a credit value above a threshold and that can identify a protected class, etc. However, evaluation results can include any suitable type of information. One or more of the explanation system 110, the development system 131, the model execution system 132, the monitoring system 133, the score explanation system 134, the fairness evaluation system 135, the disparate impact evaluation system 136, the feature importance system 137 and the document generation system 138 can generate at least a portion of the evaluation results at S240 based on explanation information generated at S230.

In some variations, the model development system 131 re-trains the model 111 or adjust weights of the model in based on the explanation information generated at S230.

In some variations, the model monitoring system 133 generates a notification based on the explanation information generated at S230.

In some variations, the score explanation system 134 generates a score explanation for an evaluation input based on the explanation information generated at S230. In some implementations, the score explanation includes human-readable text that describes a cause for a model score generated for the evaluation input. In some embodiments the model explanations include a cause for a model score generated for the evaluation input with respect to multiple reference groups. In embodiments the reference groups in the explanation are comprised of demographic groups. Additionally, or alternatively, the score explanation can include human-readable text that describes a corrective action that can be taken to improve a model score generated by the model. In some embodiments, the score explanation can include human-readable text that describes corrective actions that can be taken to achieve one or many model-driven outcomes (for example: to qualify as grade A, you must change X; to qualify as grade B, you must change Y; and so on).

In some variations, the fairness evaluation system 135 uses the explanation information generated at S230 to determine whether features having credit values above a threshold value can be used to identify a protected class. In some implementations, the fairness evaluation system 135 provides a notification or takes corrective action (e.g., retraining the model, adjusting model weights, etc.) if it can identify a feature that has a credit value above a threshold value and that can be used to identify a protected class.

In some variations, the disparate impact evaluation system 136 uses the explanation information generated at S230 to identify features for a reference population that have a credit value above a threshold value and identify features for a protected class population that have a credit value above a threshold value, and compare the features identified for the reference population with the features identified for the protected class population. Based on the comparison, the disparate impact evaluation system 136 determines whether certain features of the model disproportionately impact members of the protected class population, as compared to members of the reference population. In some embodiments the protected class population is an evaluation population generalized to allow the analysis of drivers of disparate outcomes between any demographic or other population attribute. The methods described herein make it practical to quickly compute credit values for features in a model between multiple population segments so as to power interactive visualizations that allow an analyst to access information via a graphical user interface or web-based application to scrutinize the drivers of model score differences between populations and assess whether a model is treating all populations fairly.

In some variations, the feature importance system 136 uses the explanation information generated at S230 to generate a list of features ranked in order of importance.

In some variations, the document generation system 136 uses the explanation information generated at S230 to automatically generate documentation for the model (e.g., by directly including the explanation information in a document, generating additional information by using the explanation information, etc.). In some implementations, the documentation can include information explaining variance across different values for a given feature by using the explanation information generated at S230.

However, any suitable evaluation process can be performed at S240 to generate one or more evaluation results.

Providing an evaluation result S250 can include providing an evaluation result generated at S240 to any suitable system, storage device, or component via one or more of a notification, an application programming interface (API), a user interface, etc. However, evaluation results can be provided in any suitable manner.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

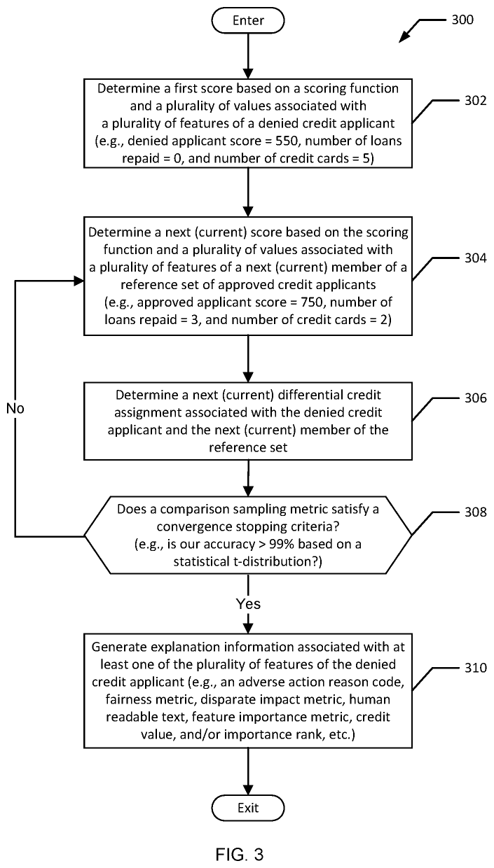

FIG. 3 is a flowchart of an example process of generating explanation information associated with denied credit applicant in a machine learning system. Although the process 300 is described with reference to the flowchart illustrated in FIG. 3, it will be appreciated that many other methods of performing the acts associated with process x300 xx may be used. For example, the order of many of the operations may be changed, and some of the operations described may be optional.

In this example, the process 300 begins by determining a first score based on a scoring function and a plurality of values associated with a plurality of features of a denied credit applicant (block 302). For example, the denied applicant may have a credit score of 550, no loans repaid, and 5 credit cards. The process 300 then determines a next (current) score based on the scoring function and a plurality of values associated with a plurality of features of a next (current) member of a reference set of approved credit applicants (block 304). For example, the approved applicant may have a credit score of 750, 3 loans repaid, and 2 credit cards. The process 300 then determines a next (current) differential credit assignment associated with the denied credit applicant and the next (current) member of the reference set (block 306).

The process 300 then determines if a comparison sampling metric satisfies a convergence stopping criteria (block 308). For example, a check may be made to see if the current accuracy>99% based on a statistical t-distribution. If the convergence stopping criteria is not satisfied, the process 300 determines a next (current) score based on the scoring function and a plurality of values associated with a plurality of features of a next (current) member of a reference set of approved credit applicants (block 304). If the convergence stopping criteria is satisfied, the process 300 generates explanation information associated with at least one of the plurality of features of the denied credit applicant (block 310). For example, the explanation information may include an adverse action reason code, fairness metric, disparate impact metric, human readable text, feature importance metric, credit value, and/or an importance rank.

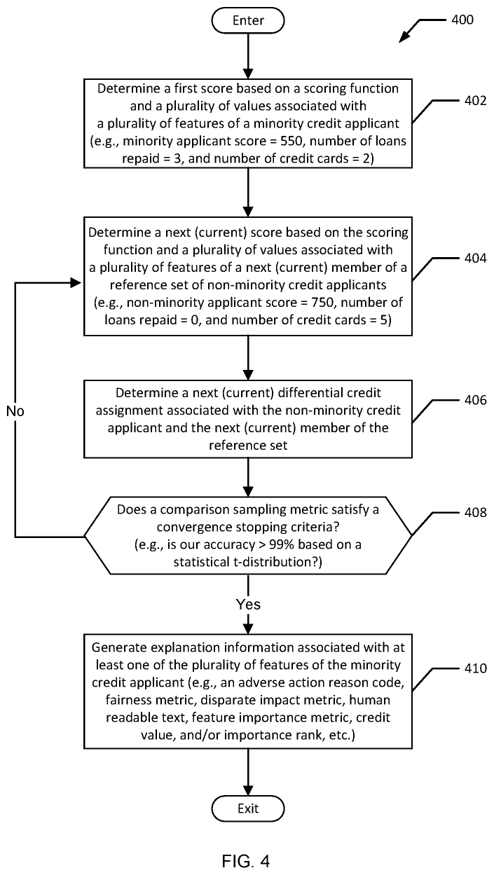

FIG. 4 is a flowchart of an example process of generating explanation information associated with minority credit applicant in a machine learning system. Although the process 400 is described with reference to the flowchart illustrated in FIG. 4, it will be appreciated that many other methods of performing the acts associated with process 400 may be used. For example, the order of many of the operations may be changed, and some of the operations described may be optional.

In this example, the process 400 begins by determining a first score based on a scoring function and a plurality of values associated with a plurality of features of a minority credit applicant (block 402). For example, the minority applicant may have a credit score of 550, no loans repaid, and 5 credit cards. The process 400 then determines a next (current) score based on the scoring function and a plurality of values associated with a plurality of features of a next (current) member of a reference set of non-minority credit applicants (block 404). For example, the non-minority applicant may have a credit score of 750, 3 loans repaid, and 2 credit cards. The process 400 then determines a next (current) differential credit assignment associated with the denied credit applicant and the next (current) member of the reference set (block 406).

The process 400 then determines if a comparison sampling metric satisfies a convergence stopping criteria (block 408). For example, a check may be made to see if the current accuracy>99% based on a statistical t-distribution. If the convergence stopping criteria is not satisfied, the process 400 determines a next (current) score based on the scoring function and a plurality of values associated with a plurality of features of a next (current) member of a reference set of non-minority credit applicants (block 404). If the convergence stopping criteria is satisfied, the process 400 generates explanation information associated with at least one of the plurality of features of the minority credit applicant (block 410). For example, the explanation information may include an adverse action reason code, fairness metric, disparate impact metric, human readable text, feature importance metric, credit value, and/or an importance rank.

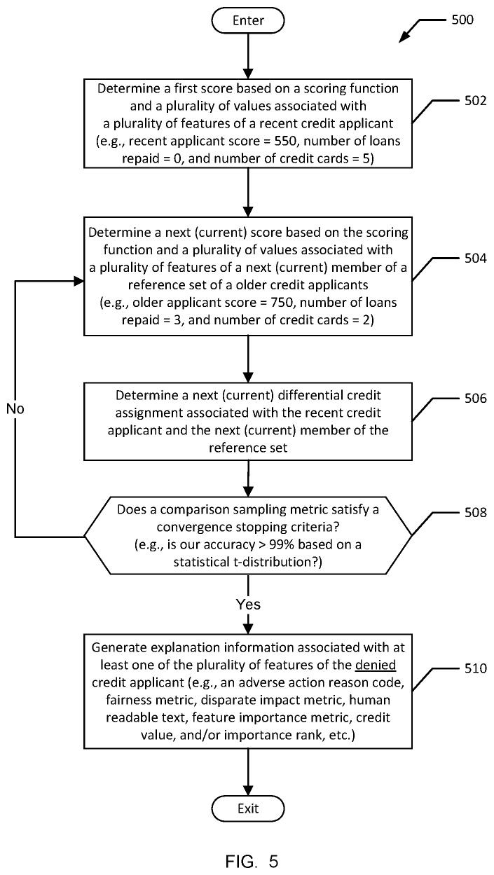

FIG. 5 is a flowchart of an example process of generating explanation information associated with recent credit applicant in a machine learning system. Although the process 500 is described with reference to the flowchart illustrated in FIG. 5, it will be appreciated that many other methods of performing the acts associated with process 500 may be used. For example, the order of many of the operations may be changed, and some of the operations described may be optional.

In this example, the process 500 begins by determining a first score based on a scoring function and a plurality of values associated with a plurality of features of a recent credit applicant (block 502). For example, the recent applicant may have a credit score of 550, no loans repaid, and 5 credit cards. The process 500 then determines a next (current) score based on the scoring function and a plurality of values associated with a plurality of features of a next (current) member of a reference set of older credit applicants (block 504). For example, the older applicant may have a credit score of 750, 3 loans repaid, and 2 credit cards. The process 500 then determines a next (current) differential credit assignment associated with the recent credit applicant and the next (current) member of the reference set (block 506).

The process 500 then determines if a comparison sampling metric satisfies a convergence stopping criteria (block 508). For example, a check may be made to see if the current accuracy>99% based on a statistical t-distribution. If the convergence stopping criteria is not satisfied, the process 500 determines a next (current) score based on the scoring function and a plurality of values associated with a plurality of features of a next (current) member of a reference set of older credit applicants (block 504). If the convergence stopping criteria is satisfied, the process 500 generates explanation information associated with at least one of the plurality of features of the recent credit applicant (block 510). For example, the explanation information may include an adverse action reason code, fairness metric, disparate impact metric, human readable text, feature importance metric, credit value, and/or an importance rank.

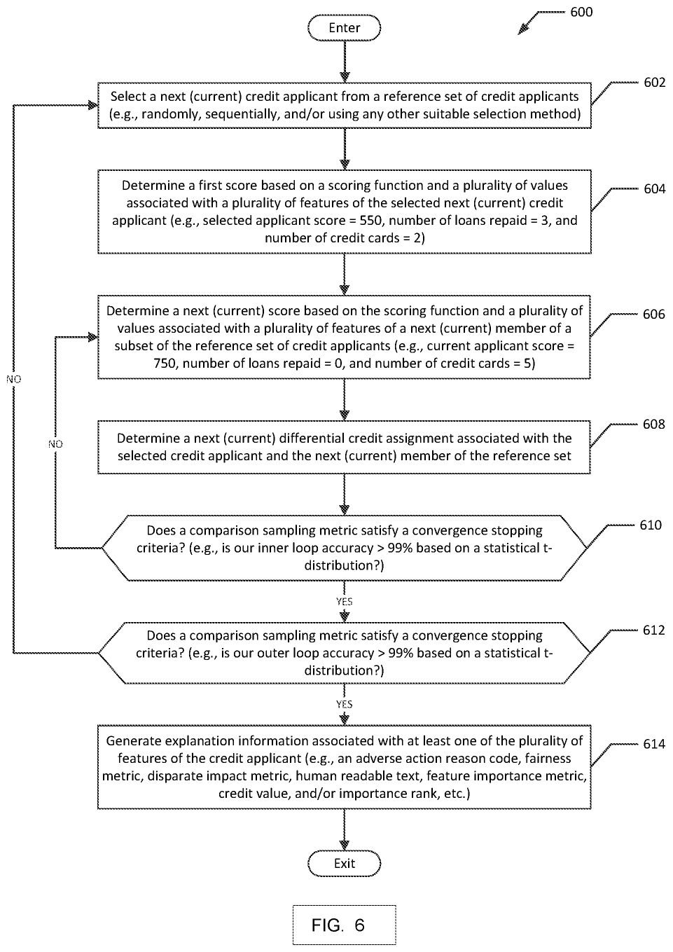

FIG. 6 is a flowchart of an example process of generating explanation information associated with feature importance in a machine learning system. Although the process 600 is described with reference to the flowchart illustrated in FIG. 6, it will be appreciated that many other methods of performing the acts associated with process 600 may be used. For example, the order of many of the operations may be changed, and some of the operations described may be optional.

In this example, the process 600 begins by selecting a next (current) credit applicant from a reference set of credit applicants (block 602). For example, the credit applicant may be selected randomly, sequentially, and/or using any other suitable selection method. The process 600 then determines a first score based on a scoring function and a plurality of values associated with a plurality of features of the selected credit applicant (block 604). For example, the selected applicant may have a credit score of 550, no loans repaid, and 5 credit cards.

The process 600 then determines a next (current) score based on the scoring function and a plurality of values associated with a plurality of features of a next (current) member of a subset of the reference set of credit applicants (block 606). For example, the applicant may have a credit score of 750, 3 loans repaid, and 2 credit cards. The process 600 then determines a next (current) differential credit assignment associated with the selected credit applicant and the next (current) member of the reference set (block 608).

The process 600 then determines if a comparison sampling metric satisfies a convergence stopping criteria (block 610). For example, a check may be made to see if the current inner loop accuracy>99% based on a statistical t-distribution. If the convergence stopping criteria is not satisfied, the process 600 determines a next (current) score based on the scoring function and a plurality of values associated with a plurality of features of a next (current) member of a subset of the reference set of approved credit applicants (block 606).

If the convergence stopping criteria is satisfied, the process 600 determines if a comparison sampling metric satisfies a convergence stopping criteria (block 612). For example, a check may be made to see if the current outer loop accuracy>99% based on a statistical t-distribution. If the convergence stopping criteria is not satisfied, the process 600 selects a next (current) credit applicant from the reference set of credit applicants (block 602).

If the convergence stopping criteria is satisfied, the process 600 generates explanation information associated with at least one of the plurality of features of the credit applicant (block 612). For example, the explanation information may include an adverse action reason code, fairness metric, disparate impact metric, human readable text, feature importance metric, credit value, and/or an importance rank.

In summary, persons of ordinary skill in the art will readily appreciate that methods and apparatus for cleaning a mat have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

What is claimed is:

1. A method of generating explanation information associated with a machine learning system, the method comprising:
determining a first score based on a scoring function and a plurality of values associated with a plurality of features of a denied credit applicant;
determining a second score based on the scoring function and a plurality of values associated with a plurality of features of a first member of a reference set of approved credit applicants;
determining a first differential credit assignment associated with the denied credit applicant and the first member of the reference set;
determining if a comparison sampling metric satisfies a convergence stopping criteria;
determining a second differential credit assignment associated with the denied credit applicant and a second member of the reference set, if the convergence stopping criteria is not satisfied; and
generating explanation information associated with at least one of the plurality of features of the denied credit applicant, if the convergence stopping criteria is satisfied.

2. The method of claim 1, wherein the scoring function includes a marketing model.

3. The method of claim 1, wherein the scoring function includes an identity fraud model.

4. The method of claim 1, wherein the scoring function includes an underwriting model.

5. The method of claim 1, wherein the scoring function includes a pricing model.

6. The method of claim 1, wherein the scoring function includes a line assignment model.

7. The method of claim 1, wherein the scoring function includes a portfolio review model.

8. The method of claim 1, wherein the at least one of the plurality of features of the denied credit applicant includes a number of loans repaid.

9. The method of claim 1, wherein the at least one of the plurality of features of the denied credit applicant includes a number of credit cards.

10. The method of claim 1, wherein the at least one of the plurality of features of the denied credit applicant includes a credit score.

11. The method of claim 1, wherein the at least one of the plurality of features of the denied credit applicant includes a number of bankruptcies.

12. The method of claim 1, wherein the at least one of the plurality of features of the denied credit applicant includes a number of payment delinquencies.

13. The method of claim 1, wherein the at least one of the plurality of features of the denied credit applicant includes outputs of other models.

14. The method of claim 1, wherein the at least one of the plurality of values associated with a plurality of features of the denied credit applicant is synthetically generated.

15. The method of claim 14, wherein on the synthetically generated value is based on a generative model.

16. The method of claim 1, wherein the at least one of the plurality of features of the approved credit applicant includes a number of loans repaid.

17. The method of claim 1, wherein the at least one of the plurality of features of the approved credit applicant includes a number of credit cards.

18. The method of claim 1, wherein the at least one of the plurality of features of the approved credit applicant includes a credit score.

19. The method of claim 1, wherein the at least one of the plurality of features of the approved credit applicant includes a number of bankruptcies.

20. The method of claim 1, wherein the at least one of the plurality of features of the approved credit applicant includes a number of payment delinquencies.

21. The method of claim 1, wherein the at least one of the plurality of features of the approved credit applicant includes outputs of other models.

22. The method of claim 1, wherein the at least one of the plurality of values associated with a plurality of features of the approved credit applicant is synthetically generated.

23. The method of claim 22, wherein on the synthetically generated value is based on a generative model.

24. The method of claim 1, wherein determining the first differential credit assignment is based on Shapley values.

25. The method of claim 1, wherein determining the first differential credit assignment is based on Aumann-Shapley values.

26. The method of claim 1, wherein determining the first differential credit assignment is based on Tree SHAP values.

27. The method of claim 1, wherein determining the first differential credit assignment is based on Kernel SHAP values.

28. The method of claim 1, wherein determining the first differential credit assignment is based on interventional tree SHAP values.

29. The method of claim 1, wherein determining the first differential credit assignment is based on Integrated Gradients values.

30. The method of claim 1, wherein determining the first differential credit assignment is based on Generalized Integrated Gradients values.

31. The method of claim 1, wherein the convergence stopping criteria is based on a statistical t-distribution.

32. The method of claim 1, wherein the convergence stopping criteria includes a confidence interval.

33. The method of claim 1, wherein the convergence stopping criteria includes a tolerance level.

34. The method of claim 1, wherein the convergence stopping criteria includes a numerical range.

35. The method of claim 1, wherein the convergence stopping criteria includes a number of iterations.

36. The method of claim 1, wherein the convergence stopping criteria includes a wall-clock runtime limit.

37. The method of claim 1, wherein the convergence stopping criteria includes an accuracy constraint.

38. The method of claim 1, wherein the convergence stopping criteria includes uncertainty constraint.

39. The method of claim 1, wherein the convergence stopping criteria includes performance constraint.

40. The method of claim 1, wherein the explanation information includes at least one adverse action reason code.

41. The method of claim 1, wherein the explanation information includes at least one fairness metric.

42. The method of claim 1, wherein the explanation information includes at least one disparate impact metric.

43. The method of claim 1, wherein the explanation information includes human readable text.

44. The method of claim 1, wherein the explanation information includes at least one feature importance metric.

45. The method of claim 1, wherein the explanation information includes at least one credit value.

46. The method of claim 1, wherein the explanation information is ranked in order of importance.

47. The method of claim 1, wherein the explanation information model includes model documentation.

48. The method of claim 1, wherein the explanation information model includes model analysis documentation.

49. The method of claim 1, wherein the explanation information includes a list of model features to be removed from the model.

50. The method of claim 1, wherein the explanation information includes updated model weights.

51. The method of claim 1, wherein the explanation information includes a model score explanation.

52. The method of claim 1, further comprising generating a notification based on the explanation information.

53. A method of generating explanation information associated with a machine learning system, the method comprising:
determining a first score based on a scoring function and a plurality of values associated with a plurality of features of a minority credit applicant;
determining a second score based on the scoring function and a plurality of values associated with a plurality of features of a first member of a reference set of non-minority credit applicants;
determining a first differential credit assignment associated with the minority credit applicant and the first member of the reference set;
determining if a comparison sampling metric satisfies a convergence stopping criteria;
determining a second differential credit assignment associated with the minority credit applicant and a second member of the reference set, if the convergence stopping criteria is not satisfied; and
generating explanation information associated with at least one of the plurality of features of the minority credit applicant, if the convergence stopping criteria is satisfied.

54. A method of generating explanation information associated with a machine learning system, the method comprising:
determining a first score based on a scoring function and a plurality of values associated with a plurality of features of a recent credit applicant;
determining a second score based on the scoring function and a plurality of values associated with a plurality of features of a first member of a reference set of older credit applicants;
determining a first differential credit assignment associated with the recent credit applicant and the first member of the reference set;
determining if a comparison sampling metric satisfies a convergence stopping criteria;
determining a second differential credit assignment associated with the recent credit applicant and a second member of the reference set, if the convergence stopping criteria is not satisfied; and
generating explanation information associated with at least one of the plurality of features of the recent credit applicant, if the convergence stopping criteria is satisfied.

55. A method of generating explanation information associated with a machine learning system, the method comprising:
selecting a first credit applicant from a reference set of credit applicants;
determining a first score based on a scoring function and a plurality of values associated with a plurality of features of the selected credit applicant;
determining a second score based on the scoring function and a plurality of values associated with a plurality of features of first member of a subset of the reference set of credit applicants;
determining a first differential credit assignment associated with the selected credit applicant and the first member of the reference set;
determining if a first comparison sampling metric satisfies a first convergence stopping criteria;
determining a second differential credit assignment associated with the selected credit applicant and a second member of the reference set, if the first convergence stopping criteria is not satisfied;
determining if a second comparison sampling metric satisfies a second convergence stopping criteria, if the first convergence stopping criteria is satisfied;
selecting a second credit applicant from the reference set of credit applicants, if the second convergence stopping criteria is not satisfied;
generating explanation information associated with at least one of the plurality of features of the selected credit applicant, if the second convergence stopping criteria is satisfied.
